(19) United States
(12) Patent Application Publication
(10) Pub. No.: US 2011/0196783 A1
(43) Pub. Date: Aug. 11, 2011

(54) WIRELESS PAYMENT PLATFORM AND MOBILE RESELLER SYSTEM

(76) Inventor: Gad Liwerant, Chestnut Hill, MA (US)

(21) Appl. No.: 13/004,430

(22) Filed: Jan. 11, 2011

Related U.S. Application Data
(60) Provisional application No. 61/293,873, filed on Jan. 11, 2010.

(51) Int. Cl. G06Q 40/00

(52) U.S. Cl. 705/39

(57) ABSTRACT

The present invention is directed to a wireless payment platform that may offer a payment mechanism for users with a mobile device and may allow users to exchange virtual currency for payment. The wireless payment platform may utilize the convenience and adaptability of the mobile device of the users. Such a payment mechanism may offer more security to transactions by adding a transaction confirmation facility using conventional communications technologies, such as the Short Message Service or SMS, Interactive Voice Response (IVR) technology, and the like. Financial transactions may be conducted on a person-to-person basis where each user may be identified by a unique identifier such as a telephone number, caller ID, and the like.

### CROSS REFERENCE

This application claims the benefit of the following provisional application which is hereby incorporated herein by reference in its entirety: Ser. No. 61/293,873, titled WIRELESS PAYMENT PLATFORM, filed Jan. 11, 2010.

### FIELD

The present invention relates to a payment platform, more specifically the present invention relates to a multilevel wireless payment platform and mobile reseller systems for virtual and non-virtual currencies.

### DESCRIPTION OF THE RELATED ART

### Background

In recent years mobile phones have been considered an object of general use to provide a wide variety of applications. Consequently, the number of mobile device users (hereinafter “users”) has also increased significantly in these years. Various general use applications are incorporated in the mobile devices for targeting requirements of the users. The significant increase in the mobile device users in the recent years have caused a strong demand for secured wireless information services and reliable mobile commerce (m-commerce) applications. Mobile payment (m-payment) application is a critical part of the most wireless information services and applications. The users may make financial transactions such as payment of bills, transfer of funds, mobile shopping, and the like using mobile devices. Further, the mobile devices such as smart phones and wireless PDAs may include an application processor for verifying software that may run on the mobile devices. In addition, at the hardware level, interactions between peripherals may need to be verified. However, verification of the software and the hardware interactions as described herein above is a lengthy and tiring task.

Recent years have also seen the emergence of virtual currencies, such as used in connection with online gaming environments, bartering systems, and the like.

In light of the above discussion, there exists a need for a wireless payment platform that may allow mobile users to conduct payments in virtual currencies over wireless communication links without requiring any external software verifications. There further exists a need for a wireless payment platform that may allow the users to perform related secured transactions.

### SUMMARY

Methods and systems of the present invention are directed to a wireless payment platform that may offer a payment option for users with a mobile device. Examples of the mobile device may include, without limitation, mobile phones, IPhones, PDAs and the like. The wireless payment platform may utilize the convenience and adaptability of the mobile device of the users. The payment mechanism may offer more security to transactions by adding a transaction confirmation facility using conventional communications technologies, such as the Short Message Service or SMS, Interactive Voice Response (IVR) technology, and the like. Financial transactions may be conducted on a person-to-person basis where each user may be identified by a unique identifier such as a telephone number, caller ID, and the like.

The methods and systems may allow users to send and receive money, pay for services, pay for bills, pay for movie tickets, pay for groceries, pay a babysitter, pay for coffee and a newspaper, instantly pay back a friend, and the like. Transactions may take place in real currency, as well as in virtual currencies, such as in points that are redeemable according to agreements or protocols determined between users, as well as in the form of credits, debits, “IOUs” and the like. Further, the platform of the present invention may be integrated into existing systems operated by or for financial organizations and telecommunication service providers.

Further, the methods and systems may assign levels to the users. The users may upgrade the status of their accounts to higher levels by linking their accounts with financial sources such as a bank account, a credit card, and the like. In addition, the users may upgrade their status to other levels based on the capacity of the users to pay, available funds in their accounts, and the like.

Further, methods and systems may allow user's accounts may be created via mobile device or payment server. The mobile devices used may be coupled via payment server, Wi-Fi, Bluetooth, pager network, cellular network, 3G network, 4G network and the like.

Methods and systems may allow the transaction history to be checked via server or mobile device.

Further, the methods and systems of the present invention are directed to a mobile reseller system for virtual or non virtual currencies for individual users and/or a network of users that may include a module capable of allowing users to exchange virtual currency for payment.

### BRIEF DESCRIPTION OF THE FIGURES

FIG. 1 depicts a block diagram of a wireless payment platform in accordance with an embodiment of the present invention;

FIG. 2 depicts a block diagram of a payment server of the wireless payment platform in accordance with an embodiment of the present invention; and

FIG. 3 depicts a flow diagram of a method of conducting wireless payments in accordance with an embodiment of the present invention.

FIG. 4 depicts a diagram of a mobile reseller network for virtual currencies.

FIG. 5 depicts a method of transfer of virtual currencies between two mobile devices.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as connected, although not necessarily directly and not necessarily mechanically.

The wireless payment platform 100 hereinafter payment platform 100 for simplicity of descriptive purposes may enable financial transactions between a payer and a payee. The financial transactions between the payer and the payee may be related to money, a treasury note having a financial value, an equity share, e-money, e-cheque, an exchange note capable of increasing the airtime value of the payee and the like. It may be noted that any transaction that may result in the gain of a financial status of the recipient would be construed as the financial transaction or merely transaction for descriptive purposes without deviating from the scope and spirit of the invention. Likewise, a payee may include an individual, a profile, an organization, a government agency, a nonprofit organization, a professional or some other type of recipients. The payee may utilize a mobile facility to make the financial transactions. These transactions may be hierarchically organized into different levels thereby forming a multilevel payment platform. As noted above, the transaction may also be in a virtual currency, a point system, an IOU, or similar unit, such as used in gaming, barter, trading, or the like. For example, a transaction may allow a user to send a friend a transaction that indicates “I owe you one meal at our favorite restaurant.”

The scope of levels may be defined based on the scenario and the requirements. For example, in one scenario Level One service may allow transaction up to a predetermined limit, such as 100 dollars, while a Level Two service may allow a transaction up to a limit of 500 dollars based on the trust relationship between a payer and a payee. Alternatively, the levels may be categorized according to user characteristics including but not limited to age, profession, financial status, trust relationship, credit history, transaction history and the like; transaction status of the user, transaction environment, and the like. The transaction environment for example, may signify whether the transaction is conducted between unregistered users, registered users, or between a registered user and an unregistered user. In alternative embodiments, the transaction may enable the users to pay wirelessly for various other services such as mobile shopping, banking, and the like.

In an embodiment, the payment platform 100 may be installed at a particular telecommunications service provider end. However, in alternative embodiments, the payment platform 100 may be installed at a financial institution or may also be a separate payment platform 100 acting as an intermediary for enabling the financial transactions to such as the mobile phone users. The users of the specific service provider may be able to use the above mentioned services through various mobile devices such as mobile phones, cellular phones, palmtops, laptops, Personal Digital Assistants (PDA's), IPHONEs, internet enabled telephonic devices, cordless telephones and other similar telephonic devices incorporating wireless features.

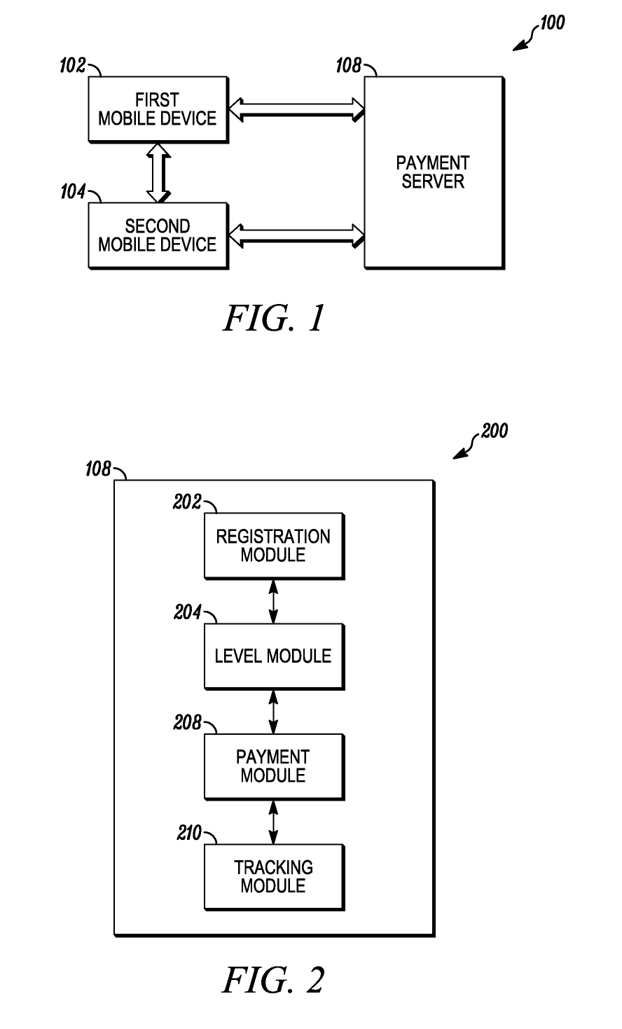

Referring to FIG. 1, the payment platform 100 may include a first mobile device 102, a second mobile device 104, and a payment server 108. Examples of the first mobile device 102 and the second mobile device 104 may include, without limitation, a cellular phone, a Personal Digital Assistant (PDA), an IPHONE, a mobile phone, a cellular phone, a palmtop, a laptop, an internet enabled telephonic device, a cordless telephone and other similar telephonic devices incorporating wireless features. The first mobile device 102 and the second mobile device 104 may for example interact with a payment server 108 via a messaging service. The messaging service may be a Short Messaging Service (SMS), Interactive Voice Response (IVR) or other messaging applications that may be used by the first mobile device 102 and the second mobile device 104.

Further, the payment server 108 may have a website that may include a mobile-formatted webpage through which the users may interact with the payment server 108 via mobile devices such as the first mobile device 102 and the second mobile device 104. The payment server 108 may also include a database that may be configured to store the received messages from the mobile devices such as the mobile device 102 and the mobile device 104, user profiles including respective account details, personal details and transaction related information. The stored information may be utilized to identify and associate accounts with the users, and automatically authenticate the received messages with the users' profiles and accounts.

In an embodiment of the present invention, the association between the mobile devices such as the mobile device 102 and the mobile device 104, and the payment server 108 may be of Level One type. The Level One type of connection implies an informal, ad-hoc and unplanned arrangement. In accordance to this embodiment of the present invention, the users may transact with one another mutually using their mobile devices such as the mobile device 102 and the mobile device 104. In a scenario, the transaction may take place when the users are in close proximity and the users may simply shake the mobile device such as the mobile device 102 to make the payment. The users may, however, be distantly located and the payment may be made through known wireless techniques such as Short Messaging Service (SMS), Wi-Fi, Bluetooth, email, telephonic call, authenticating a PIN or a code, pager network, cellular network, 3G network, 4G network and the like. Shaking the device when in proximity may be just one way of enabling mobile devices to communicate with one another, it will be understood that any method of mobile-to-mobile communication is useful in the invention whether in proximity or distant. In embodiments, communication between mobile device 102 and 104 may be confirmed with server.

In an embodiment of the present invention, the payment server 108 may facilitate communication between the mobile devices 102 and 104. Mobile device 102 and/or 104 may send data to payment server 108 which may then send data to mobile device 102 and or 104. By way of example, mobile user one may send data to payment server 108 via mobile device 104 to add credit to mobile user two. Payment server 108 may then send data to mobile device 104 for user two to receive such credit. In embodiments, mobile device 102 may also receive a confirmation of such transaction.

The payment in a Level One type may be based on trust among the users as no financial institution is active in the mode of transaction. The transaction may merely take place based on the trust among the users. In one example, when a user requires airtime for the mobile device 104, the user possessing the mobile device 102 may simply transfer the airtime from the mobile device 102 to the mobile device 104. In another example, the user may also transfer an equivalent amount of money from the mobile device 102 to the mobile device 104. Accordingly, an equivalent airtime may be deducted from the mobile device 102. The transaction may be achieved through the payment server 108. The mobile device 102 may not be allowed to perform the transfer until the payment server 108 sends a ‘go-ahead’ message at the user interface of the mobile device 102. The ‘go-ahead message’ may be confirmed by the user of the mobile device 102 along with the confirmation of details of the mobile device 104. The mobile device 104 may then also be required to confirm the transaction. Once, the final confirmation is done, the payment server 108 may allow the mobile device 102 to proceed with the transaction.

The triggering of the payment server 108 for sending the ‘go-ahead’ message by the mobile device 102 may be automatic and the message may be generated and sent to the mobile device 102 as soon as the mobile device 102 attempts to transact or the mobile device 104 tries to send a request for the transaction to the mobile device 102. In another scenario, the triggering may be possible by sending a request to the payment server 108 by the mobile device 102.

The mobile devices such as the mobile device 102 and the mobile device 104 may be registered with the payment server 108 or may not be registered. However, when a mobile device such as the mobile device 102 and the mobile device 104 transacts or attempt to transact, the mobile devices may get automatically registered with the payment platform 100. This may be termed as a temporary registration. In another scenario, the mobile devices may also get registered permanently with the payment platform 100. Both, the temporary as well as the permanent registration may allow the transaction through the payment server 108. However, a user registered temporarily may not enjoy all the services of the payment platform 100. For example, the mobile device 102 may not transact beyond a predefined limit such as 100 dollars or the like, the mobile device 102 may not transact outstation mobile devices, the mobile device 102 may have to bear the risk completely in case of fraudulent user of the mobile device 104. However, the permanent registration may allow extensive services to the registered users. The permanently registered user for example possessing the mobile device 102 may transact with an unlimited amount. The payment server 108 may charge a fixed percentage of the transaction with one or more of the mobile device 102 and the mobile device 104 in return of providing the service to the users. The charge may be lesser for permanently registered users than for the temporarily registered users.

In accordance to another embodiment of the present invention, the connection between the mobile devices such as the mobile device 102 and the mobile device 104, and the payment server 108 may be of Level Two type. In this embodiment, the mobile devices such as mobile device 102 and the mobile device 104 may be linked with a financial institution that can make the payment through a bank account, credit card, PAYPAL and the like. The payment server 108, however, may receive the payment intermittently. The transaction through this mode may be fully authenticated and fraud proof and does not depend on the mutual trust between the users like in case of Level One type of mode.

A mobile device such as the mobile device 102 or the mobile device 104 may be registered either in Level One type or in Level Two type depending on the user's preferences. However, the payment platform 100 may also issue the type of levels to a mobile device such as the mobile device 102 or the mobile device 104 based on the defined conditions like the time period. For example, upon registration the mobile device such as the mobile device 102 or the mobile device 104 may first be issued with a Level One Type connection and upon successful completion of a fixed time limit may be provided with the Level Two Type connection if the user's transaction history, trust levels, billing related matters and several other such parameters are in accordance to the requirements of the payment platform 100.

Referring to FIG. 2, a detailed view 200 of the payment server 108 of the payment platform 100 is illustrated. The payment server 108 may include a registration module 202, an assignment module 204, a payment module 208 and a tracking module 210. The registration module 202 may perform the processes involved in the registration of the users with the payment server 108. The registration as described in conjunction with FIG. 1 may be temporary or permanent. The payment server 108 may further include an input facility that may receive the requests of the users for transaction and other user details such as name of the user, address of the user, transaction details and the like. The registration module 202 may further include a first database that stores these details. The first database may be segregated separately into two portions for temporarily registered users and permanently registered users. The information regarding temporarily registered users may be removed as soon as the transaction is over or after a certain period of time. In another scenario, the information however may be kept for record purposes. The information in the second portion of the first database may be stored permanently and kept updated from time to time. The first database may be updated only by authorized personnel. In another embodiment, the first database may be automatically updated without any requirement of manual intervention. The payment server 108 may create an account for each registered user that may include transaction related details along with the user identity and personal details. The account information is also stored in the first database. Accounts may be created at a server or from a mobile device. For example, a user Payee or Payor may register via server or via mobile device. The payment server 108 may further include an assignment module 204. The assignment module 204 may assign a status to the users, based on the kind of mode of operation and the level associated with the users. The different levels such as Level One or Level Two are described in conjunction with FIG. 1 in details. In one scenario, the users may be assigned a Level One status with the payment server 108 in accordance with the criteria of the registration with the Level One status. The users with Level One status may perform only informal, ad-hoc and unplanned financial transactions such as transferring funds through mobile devices such as the mobile device 102 or the mobile device 104. The transaction in this case may merely take place based on the trust among the users and the payment server 108 may not bear any liability for fraudulent cases. In general, the users may use this mode of transaction for transacting with friends, family members and close relatives and neighbors.

In accordance to another embodiment of the present invention, the users may be assigned a Level Two type status with the payment server 108 by the assignment module 204. This is achieved in accordance with the criteria of the registration with the Level One status. In this embodiment, the mobile devices such as mobile device 102 and the mobile device 104 may be linked with a financial institution that can make the payment through a bank account, credit card, PAYPAL and the like. Therefore, the payment server 108 may authorize the transactions based on the credits and account limits of the users in the financial institution and hence the scope of fraudulent transactions may be avoided. Level Two may be a secured mode of transaction and a user may have to pay an additional amount to the payment platform 100 for receiving the status of Level Two.

The payment server 108 may also include a payment module 208. The payment module 208 may receive the transferred funds, bill payments, and the like generated from a payer through their mobile devices such as the mobile device 102 and the mobile device 104. The payment module 208 may also generate prompts for a payer and a payee to confirm the transfer of funds. For example, a user of the first mobile device 102 may send a message such as a text message to the payment server 108 after making the payments corresponding to a financial transaction. The message may include a code such as “Pay to XYZ” or other similar identification details that may be understood and decoded by the payment server 108. In an embodiment, an automated message may be delivered indicating the payment module 208 regarding the payment. The message may thus facilitate the payment module 208 to recognize a request of the user of the first mobile device 102 and initiate a transaction. The payment server 108 may recognize the first mobile device 102 through a caller ID, and the like.

In case the user, for example possessor of the mobile device 102, has a status of Level Two, the code “XYZ” may also include a list of the accounts' name that the user may have in financial institutions and indicating any preferences of the user regarding payment if the user has accounts in multiple financial institutions. The code, in one scenario, may be transmitted to the respective financial institution also prior to any payment. However, the entire process may be controlled by the payment server 108 irrespective of any involvement of the financial institution regarding the authorization of the transactions and the payments. The financial institution may merely act as a source to credit an amount from the user's account. However, in another embodiment of the present invention, the users may also hold an account with the payment platform 100 also and the payment platform 100 may also act as a small bank or financial institution. It must be understood that all the processes and steps that are in general performed by the financial institutions as understood conventionally may be adopted by the payment platform 100 also. In such scenario, the users may be motivated to start with an account with the payment platform 100 itself by issuing various schemes. The payment platform 100 may facilitate the users to open accounts for free who are registered with the payment platform 100. The users may also be provided with an enhanced credit limit or may be guaranteed no fraudulent transactions even for Level Two status depending on the predefined conditions set by the payment platform 100.

The payment module 208 may facilitate the payment server 108 to determine which account is to be credited, i.e. an account associated with the user of the second mobile device 104. The credited account may be different from the account of the user of the second mobile 104 and even the account of the user of the first mobile 102 also who is the payee. However, in case the account from where the amount is credited does not match the details of the user of the second mobile 104, the payment module may generate a message to provide a confirmation from the user whose account needs to be credited. In a scenario, the message requiring confirmation may be directly sent to the user whose account needs to be credited. Based on the confirmation status, the payment module 208 may authenticate the transaction and the user of the mobile device 102 may get access rights to transact with the user of the mobile device 104. In an embodiment of the present invention, the payment module 208 may ask the user of the first mobile device 102 via SMS or other text messaging service or any other wireless adopted service and may include a prompt for the user of the first mobile device 102 to enter some identification information associated with the second mobile device 104 and the user whose account needs to be credited. Further, the payment module 208 may require the user of the first mobile device 102 to enter the amount to be transferred to the user of the second mobile device 104. In embodiments, users may check the status of a transaction via server or via mobile device. It must be understood by a person ordinarily skilled in the art that various other similar tasks may be performed by the payment module 208 regarding the payments and the financial transactions without limiting the spirit and scope of the present invention.

The payment module 208 may also include a second database that stores information regarding transactions and payments made by the users through the payment platform 100. In an embodiment of the present invention, the second database may store the information temporarily and as soon as the transaction finishes, the information may be transferred to the first database which is linked with the second database. Therefore, the first database gets updated intermittently regarding the transactions and payments. In an alternate embodiment, the information may be stored permanently in the second database and it acts as a backup to the first database for information regarding payments. The present invention has been described illustrating the services of transferring airtime from the mobile device 102 to the mobile device 104, however, it must be clearly understood by a person ordinarily skilled in the art that several other services may also be performed via the financial transactions as illustrated in the present invention through the payment platform 100. For example, the users may transfer funds using an IPHONE through the disclosed payment platform 100. In an embodiment, the financial institutions such as banks may be interlinked via the payment server 108. The interlinking may create a networked environment that provides a unique platform for all the financial institutions worldwide to facilitate and ease payments from one financial institution to another. Further, various wireless service providers and telephony service providers may also be connected through the disclosed payment platform 100 that allows easy amount recharging or airtime transfer of the mobile devices such as the mobile device 102 and the mobile device 104 even for different telephony service providers.

The payment server 108 may be configured to receive various types of wireless signals from the mobile devices such as mobile device 102. The agency deploying the payment platform 100 may also issue customized mobile devices, such as the mobile device 102, that are automatically registered with the payment server 108. These devices may have specific additional features that may allow these mobile devices to connect with payment server 108 with ease. For example, the mobile devices, such as the mobile device 102, may have a shake facility. The shake facility may enable the users to initiate a request for the processing of the transaction by simply shaking their mobile devices, such as the mobile device 102. The users having the mobile devices, such as the mobile device 102, at a proximal distance from another mobile device, such as mobile device 104, may transact among themselves by simply shaking the mobile devices. The payment server 108 may be configured to identify and process the signals transmitted by the mobile device 102 through shaking.

In an embodiment of the present invention, the payment server 108 may also recognize and process the signals transmitted by the shaking of the mobile device 102 even if the mobile device is not custom manufactured and issued as an element of the payment server 108. In accordance to various embodiments of the present invention, the users may perform money transfer related operations through the payment server 108. The money or funds may first be transferred from the account of the user corresponding to the mobile device 102 to the payment server 108 and subsequently upon authentication by the mobile device 104, the money may be transferred from the payment server 108 to the account of the user of the mobile device 104. The users may transfer funds using a personal identification number (PIN) before initiating any transaction. For example, the user of the first mobile device 102 may transfer funds into the account of the user of the second mobile device 104. The user of the second mobile device 104 may need to provide identification information such as PIN, and the like, for authenticating the fund transfer request before receiving funds therein. The wireless payment platform 100 may allow transfer of the funds between the users through the payment server 108 only. For example, in order to transfer funds to the user of the second mobile device 104, the user of the first mobile device 102 may need to transfer funds to the account of the user of the second mobile device 104 that may be created on the payment server 108. The users, however, may be allowed to directly transfer the funds bypassing the payment server 108 upon special requests on being approved by the payment server 108. However, the payment server 108 may charge the users for this special service depending on the circumstances.

In accordance to various embodiments of the present invention, the Level One users may upgrade their status to Level Two users by linking their accounts with a financial source such as a bank account, a credit card, PAYPAL, and the like. The financial source may make payments on behalf of the users similar to a bank account. For example, if a Level Two user shops for some items online, the financial source associated with the second level user may need to pay for the purchased items. Further, the wireless payment platform 100 may enable the users to transfer cash to a financial source of their choice. In addition, users may transfer cash though a check requested by the users at a registered address such as at an office, a residence and the like. In addition, the Level One users may also be upgraded to Level Two users by connecting with another Level Two user instead of a financial institution directly. In this scenario, the Level Two user may have to pay on behalf of the Level One user.

In embodiments, a third level may be assigned to the users that may command interest on the funds transferred from their accounts to other users. For example, a Level Three user may transfer funds into the account of a Level Two user. If the Level Two user is not able to return the funds taken from the Level Three user in a predefined time limit, the Level Three user may command an interest of a predetermined percentage on the funds for every additional day. Similarly, users may attain other levels based on the capacity of the users to pay/transfer funds, based on the assigned credit limits, and the like. Other Levels may also be included without limiting the spirit and scope of the present invention such as based on credit capacity, transaction history and the like. Accordingly, the users may be rated with stars, colors or some metrics.

In an embodiment of the present invention, the payment server 108 may be connected with the stock exchange. The users who purchase stocks may be registered with the payment server 108 under a special scheme. The transaction of the stock buyers or sellers may then directly be served from the payment server 108. In a scenario, if a stock buyer loses value in the stocks, the payment server 108 may automatically compensate for the loss through an insurance policy or may lend an amount on lesser interest to motivate the users.

In addition, the payment server 108 may include a tracking module 210. The tracking module 210 may track the transaction history of users. The transaction history of the users may include records of their past transactions such as credits, debits, debts, pending bills, and the like. The payment server 108 may also rate users on the basis of trust. For example, the payment server 108 may give a star rating to a user that pays bills on time and has no debt record in the account. Similarly, the payment server 108 may designate the users with various colors based on various criteria related to the transaction history and the trustworthiness of the users.

Further, the wireless payment platform 100 may allow real cash transfer, such as through a cash transfer facility, only when the users may need to settle accounts. The users may settle their accounts by charging interest on an earlier fund transfer, by settling for a lesser amount of funds to be transferred and the like. When settling accounts, the user may be required to make a real payment by providing a link to a financial source such as the transaction ID, and the like. The payment server 108 may deduct funds from the financial sources of the user and may keep the funds in the accounts created thereon. The wireless payment platform 100 may charge some percentage of the funds transferred by the users when the users may need to settle their accounts. The percentage charged by the wireless payment platform 100 may depend upon the balance in the account of a user, total number of transactions performed, and the like.

Furthermore, the users may be able to limit the credit they may transfer to other contacts. For example, a user may fix a limit of $500 for making transfers to business associates. Similarly, the user may define various credit limits in relation to other users such as friends, unknown users, and the like.

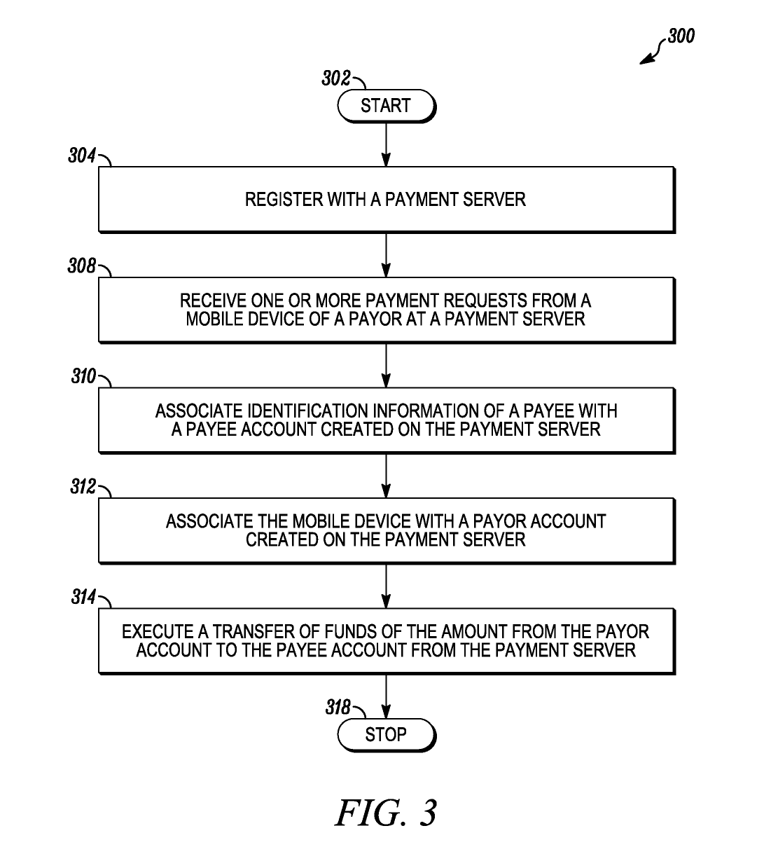

Referring to FIG. 3, a flow diagram of a method 300 for conducting wireless payments with the help of the wireless payment platform 100 in accordance with an embodiment of the present invention will be described in reference to FIG. 1 and FIG. 2.

The method 300 may start at step 302 and immediately move to step 304. At 304, a user may register with the payment server 108 using the registration module 202. The payment server 108 may create an account for each registered user; the account may be accessible only to the user. A user may be assigned a Level One status when he successfully registers with the payment server 108 through the assignment module 204. A user may be assigned a Level Two status when he links his account with a financial source such as a credit card, a bank account, and the like. The details of the registration along with the registration types and the Levels have been described in conjunction with FIG. 1 and FIG. 2 in detail. At step 308, the payment server 108 may receive one or more payment requests, such as in the form of text messages, emails, telephone calls, beeps, triggers, coded texts and the like from the user of the mobile device 102 or herein as the mobile device of a Payer.

At step 310, the payment server 108 may associate identification information of the user of the mobile device 104 or herein as the mobile device of the payee, with the payee account created on the payment server 108. The associated identification information may include user details, transaction related details and the like. The payment server 108 may also confirm these details and check the status of the payee based on the user and the transaction history. The payment module 208 may facilitate the transfer of funds, pay bills, and the like and may receive the payments. The payment module 208 may also provide prompts to a payer and a payee to confirm the transfer of funds. The prompts may be in the form of SMS, IVR, and the like. When the payer and the payee respond to the prompts of the payment module 208, the payment server 108 may initiate the fund transfer request. The payment module 208 has been described in conjunction with FIG. 2 in detail. At step 312, the payment server 108 may associate the mobile device 102 with a payer account created on the payment server 108. The association may include confirming the details of the payer along with the transaction details. Subsequently, at step 314, the payment server 108 may execute transfer of the specified amount from the payor account to the payee account through the payment server 108. The payment server 108 may track the transaction history of the users through the tracking module 210. The tracking module 210 has been described in conjunction with FIG. 2 in detail. The transaction history of the users may include records of their past transactions such as credits, debits, debts, pending bills, and the like. Finally, at step 318 the process 300 may terminate.

In embodiments of the wireless payment platform, a reseller system may be included wherein a user or network of users may buy and/or sell virtual currencies, air time and/or other digital or non digital currencies from a mobile device, wireless terminal, network or other means. A user can sell currencies from a mobile device, wireless terminal, network, or other means and receive payment in the form of cash, credit transaction, air time or any other currency and transfer virtual currencies to an account.

In embodiments of the wireless payment platform, a reseller system may be included wherein a user may access a graphical user interface on a mobile facility, personal computer or other device that may allow the user to sell virtual currency, airtime, digital currencies and the like to buyers. For such transactions, the seller may earn a commission on each transaction or a group of transactions. The buyer may pay for such exchange with cash, credit, air time, any other currency or other means. Payment may be accepted via cash, PayPal, credit, an internet payment system or other method.

In embodiments, the reseller system may include a user interface that includes a means for inputting seller and/or buyer information such that virtual currencies, airtime, digital currencies and the like may be transferred from a reseller to a buyer in exchange for payment. In other embodiments, the system may also include a means through which reseller and buyer data may be tracked in the system.

In other embodiments, the user interface of the reseller system may include a means for a buyer to contact a reseller to initiate an exchange of virtual currency, airtime, digital currency and the like for payment. Such contact may be sent to the reseller's user interface, or through other means such as through an email, instant communication, SMS, Bluetooth, Wi-Fi, pager network, cellular network, 3G network, 4G network and the like. When such communication is received, reseller may manually accept or decline such transaction or the transaction may be accepted or rejected and processed automatically.

In other embodiments, the user interface of the reseller system may include a means for a reseller to contact a buyer to initiate an exchange of virtual currency, airtime, digital currency and the like for payment. Such contact may be sent to the buyer's user interface or through other means such as through an email, instant communication, SMS, Bluetooth, Wi-Fi, pager network, cellular network, 3G network, 4G network and the like. When such communication is received, buyer may manually accept or decline such transaction or the transaction may be accepted or rejected and processed automatically.

In yet other embodiments, the transaction may be initiated through a social networking site where the buyer may contact a reseller or the reseller may contact a buyer to initiate a transaction through a user interface associated with such site. In an example only and not as a limitation, a buyer may purchase digital currency from a reseller through a user interface on a social networking site. In such an example, the digital currency may be used in connection to a game or other activity on the social networking site or it may be used for any other suitable means. The buyer, or reseller may initiate the transaction through the user interface and purchase digital currency from a seller in exchange for cash, credit card or other payment.

Referring to Fig. generally, 4, and by way of example, an Organization may procure virtual currency from a website, social network site, gaming site, a network of sites and the like via cash, credit, a PayPal transaction, an offer to sell currency, for free, or by other means. Such procurement may occur through use of one or more mobile devices and/or other Web interface. Reseller and/or network of Resellers may purchase such virtual currency from Organization via cash, credit, PayPal transaction, or by other means via one or more mobile devices and/or other Web interface. Reseller or network of Resellers may sell such virtual currency to gamers, customers and/or group of gamers or other customers via cash, credit, a PayPal transaction or any other means via one or more mobile devices and/or other Web interface. In embodiments, any sale and or group of sales may generate a commission or income for any seller. In other embodiments, a gamer, customer or group of gamers or customers may transact directly with Organization.

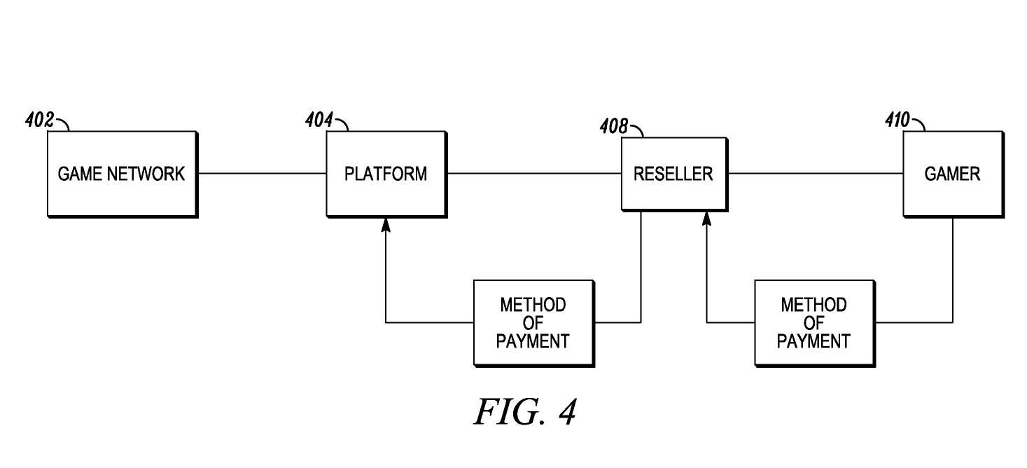

Referring to FIG. 4 specifically, Platform 404 or other organization may procure virtual currency such as game credits and the like from Game Network 402. Reseller 408 or network of resellers may then acquire the virtual currency or game credits from Platform 402 or other organization for cash, credit, other virtual currency and the like. Reseller 408 may then sell those game credits or virtual currency to Gamer 410 for cash, credit, and the like. This set of transactions may be done via web server, mobile devices and the like. In embodiments, Platform 404 may be a mobile application that Reseller 408 uses to procure virtual currency, such as on line game credits, from Game Network 402. Reseller 408 may sell procured virtual currency or game credits to Gamer. Such sales of virtual currency may be carried out between mobile devices, through the use of a web server and the like. Procurement and sale of virtual currency may be initiated by any user in the system. By way of example, a Gamer 410 may offer to buy virtual currency form Reseller 408, or Reseller 408 may ask Gamer 410 to buy virtual currency from Reseller 408. Such an application that allows transfer of virtual currency may allow ease of transactions. In an example, one mobile user may be a Reseller of virtual currency from a game network and another mobile user may be a gamer and consumer of virtual currency. The two may use a mobile platform application that allows the exchange of virtual currency from Reseller 408 to Gamer 410 for cash, credit payment, and the like. In embodiments, once in the presence of the other, the two may use a mobile platform application that allows them to shake their mobile devices to carry out such exchange. Further, the application may allow a transaction to be initiated or carried out via shaking the mobile device or via some other physical means. In other embodiments, such exchange may be carried out via mobile platform application distantly over SMS, Bluetooth, Wi-Fi, pager network, cellular network, 3G network, 4G network or other means.

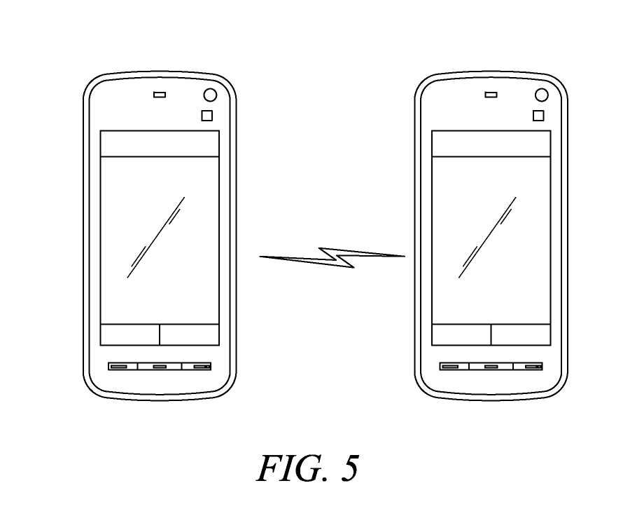

Referring to FIG. 5, Reseller may transfer virtual currency to another and another may transfer payment to Reseller by Reseller and another both shaking a mobile device in close proximity to one another. When Reseller is not in close proximity to another, the transaction may be carried out via SMS, Bluetooth, Wi-Fi, pager network, cellular network, 3G network, 4G network or other means.

In embodiments, transactions and or exchange of virtual currency may be carried out on a wireless network. Such network may be a secure network. An authentication key may be generated between two or more devices to form a secure network between said devices. The authentication key may be established at a server or on said device mobile or otherwise.

The methods and systems described herein may be deployed in part or in whole through a machine that executes computer software, program codes, and/or instructions on a processor. The processor may be part of a server, client, network infrastructure, mobile computing platform, stationary computing platform, or other computing platforms. A processor may be any kind of computational or processing device capable of executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other types of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the processor may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered a part of the infrastructure associated with the server.

The server may provide an interface with other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, codes and/or instructions. A central repository may provide program instructions to be executed on different devices. In this implementation, the remote repository may act as a storage medium for program codes, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered a part of the infrastructure associated with the client.

The client may provide an interface with other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, codes and/or instructions. A central repository may provide program instructions to be executed on different devices. In this implementation, the remote repository may act as a storage medium for program codes, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, codes, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and the steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method of conducting a wireless transaction involving virtual currency using a wireless payment system, the method comprising:
registering with a payment server of the wireless payment system;
receiving one or more virtual currency payment messages from a mobile device of a payor at a payment server;
associating identification information of a payee with a payee account created on the payment server;
associating the mobile device with a payor account created on the payment server; and
executing a transfer of virtual currency of the amount from the payor account to the payee account from the payment server.

2. The method of claim 1, wherein the mobile device of the payor is communicably coupled to a mobile device of the payee via at least one of Wi-Fi, Bluetooth, cellular network, 3G network, 4G network and pager network.

3. The method of claim 1 or 2 further comprising;
checking the status of the transaction via at least one of web server and or mobile device.

4. The method of claim 1 or 2 wherein at least one of the payor and payee account is created via mobile device.

5. A wireless virtual currency payment system comprising:
a payment server capable of executing a transfer of virtual currency of an amount from a payor account to a payee account, wherein the payor account and the payee account are created on the payment server; and
a communications module to enable a mobile device associated with a payor account to be communicably coupled to a mobile device associated with a payee account.

6. The wireless payment system of claim 5, wherein the mobile device associated with the payor account and the mobile device associated with the payee account are communicably coupled via at least one of Wi-Fi, Bluetooth, cellular network, 3G network, 4G network and pager network.

7. The wireless payment system of claim 5 or 6, wherein the payment server comprises,
a registration module capable of registering a user accessing the payment server for the first time,
a level module coupled to the registration module, the level module capable of assigning status to the users,
a payment module coupled to the level module, the payment module capable of initiating transactions between users accessing the payment server, and
a tracking module coupled to the payment module, the tracking module capable of tracking a transaction history of the users.

8. The wireless payment system of claim 7 wherein the transaction history and or status of transaction may be checked via at least one of server and mobile device.

9. The wireless payment system of claim 5 wherein at least one of the payor and payee account is created via mobile device.

10. A method of conducting a wireless transaction involving virtual currency using a wireless payment system, the method comprising:
generating an authentication key to form a secure network between a first device and a second device;
receiving one or more virtual currency payment messages from at least one of said first or second device of a payor;
associating identification information of a payee with a payee account created on the secure network;
associating the mobile device with a payor account created on the secure network; and
executing a transfer of virtual currency of the amount from the payor account to the payee account over the secure network.

11. The method of claim 10, wherein the mobile device of the payor is communicably coupled to a mobile device of the payee via at least one of Wi-Fi, Bluetooth, cellular network, 3G network, 4G network and pager network.

12. The method of claim 10, wherein the authentication key may be formed by physical contact with or movement of at least one of first and second device.
